(19) United States
(12) Patent Application Publication
(10) Pub. No.: US 2010/0015331 A1
(43) Pub. Date: Jan. 21, 2010

(54) Hot melt adhesive compositions and methods of making and using same

(75) Inventors: John O. Bieser, Houston, TX (US); Fengkui Li, Houston, TX (US); Lea Ann Nairn, League City, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 12/490,706

(22) Filed: Jun. 24, 2009

Related U.S. Application Data
(60) Provisional application No. 61/081,224, filed on Jul. 16, 2008.

(51) Int. Cl. B05D 5/10; C08L 33/08

(52) U.S. Cl. 427/207.1; 525/227

(57) ABSTRACT

A method comprising reactively extruding a polyolefin, an acrylate containing compound, and an initiator to form a polyolefin/polyacrylate blend, and applying the blend in a melted form to one or more substrates. A method comprising extruding a metallocene ethylene-propylene random copolymer to form a melt, wherein the copolymer has a melt flow rate of from 0.5 g/10 min. to 2000 g/10 min., and applying the melt to one or more substrates. A method comprising reactively extruding a metallocene ethylene-propylene random copolymer, an acrylate containing compound, and a peroxide to form a polyolefin/polyacrylate blend, wherein the blend has a melt flow rate of greater than 100 g/10 min., and applying the blend in a melted form to one or more substrates.

### CROSS-REFERENCE TO RELATED APPLICATIONS

This application claims priority to U.S. Provisional Application No. 61/081,224, filed on Jul. 16, 2008 and entitled “Hot Melt Adhesive Compositions and Methods of Making and Using Same,” which is incorporated by reference herein in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

This disclosure relates to high melt flow polymers. More specifically, this disclosure relates to polymeric compositions for use as hot melt adhesives.

2. Background

Hot-melt adhesives (HMAs) are typically thermoplastic resins which melt at elevated temperatures without degrading, form strong bonds with substrates or adherends, set rapidly upon cooling, and are relatively easy to handle. This gives rise to a variety of desirable manufacturing characteristics such as fast adhesive application rates which translate into high production rates. Additionally, HMAs are more environmentally friendly materials when compared to liquid adhesives since emissions of volatile organic compounds during the application and curing processes are minimal. HMAs are used in many industries and applications such as in aerospace, automotive, marine, military, photonics, optical, electronic devices, electrical power products, high voltage applications, semiconductors, and integrated circuit packaging.

One challenge to the use of HMAs is in the bonding of dissimilar substrates such as paper and plastic. An HMA that effectively bonds to one substrate would be expected to show a decreased affinity and ability to bond to the other substrate resulting in an overall decreased adhesion of the two substrates (e.g., paper and plastic). Thus, it would be desirable to develop HMAs having improved bonding to dissimilar substrates.

### SUMMARY

Disclosed herein is a method comprising reactively extruding a polyolefin, an acrylate containing compound, and an initiator to form a polyolefin/polyacrylate blend, and applying the blend in a melted form to one or more substrates. The polyolefin may have a melt flow rate of from 0.5 g/10 min. to 2000 g/10 min. The polyolefin may comprise polypropylene, polyethylene, a polypropylene homopolymer, a high crystallinity polypropylene, a high density polyethylene, a low density polyethylene, a linear low density polyethylene, or combinations thereof. The polyolefin may be present in an amount of from 50 wt. % to 99.8 wt. % based on the total weight of the blend. The acrylate containing compound may comprise an acrylic ester, an alkoxylated nonylphenol acrylate, a metallic diacrylate, a modified metallic diacrylate, a trifunctional acrylate ester, a trifunctional methacrylate ester, ethoxylated trimethylolpropane triacrylate, propoxylated glycerol triacrylate, tripropylene glycol diacrylate, 2-(2-ethoxyethoxy)ethyl acrylate, ethoxylated (15) trimethylolpropane triacrylate, ethoxylated (30) bisphenol A diacrylate, ethoxylated (30) bisphenol A dimethacrylate, ethoxylated (20) trimethylolpropane triacrylate, methoxy polyethylene glycol (350) monoacrylate, methoxy polyethylene glycol (350) monomethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol monomethacrylate, 1,12-dodecanediol methacrylate, 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, acrylate ester, alkoxylated aliphatic diacrylate, alkoxylated cyclohexane dimethanol diacrylate, alkoxylated hexanediol diacrylate, alkoxylated neopentyl glycol diacrylate, cyclohexane dimethanol diacrylate, diethylene glycol diacrylate, diethylene glycol dimethacrylate, dipropylene glycol diacrylate, ethoxylated (10) bisphenol A diacrylate, ethoxylated (2) bisphenol A dimethacrylate, ethoxylated (3) bisphenol A diacrylate, ethoxylated (4) bisphenol A diacrylate, ethoxylated (4) bisphenol A dimethacrylate, ethoxylated (8) bisphenol A dimethacrylate, ethoxylated bisphenol A dimethacrylate, ethoxylated (10) bisphenol dimethacrylate, ethoxylated (6) bisphenol A dimethacrylate, ethylene glycol dimethacrylate, neopentyl glycol diacrylate, nenopentyl glycol dimethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol (1000) dimethacrylate, polyethylene glycol dimethacrylate, polypropylene glycol (400) dimethacrylate, propoxylated (2) neopentyl glycol diacrylate, tetraethylene glycol diacrylate, tetraethylene glycol dimethacrylate, tricyclodecane dimethanol diacrylate, triethylene glycol diacrylate, or combinations thereof. The acrylate containing compound may be present in an amount of from 0.2 wt. % to 50 wt. % based on the total weight of the blend. The initiator may comprise an organic peroxide. The organic peroxide may comprise benzoyl peroxide, lauroyl peroxide, t-butyl peroxybenzoate, 1,1-di-t-butylperoxy-2,4-di-t-butylcyclohexane, diacyl peroxides, peroxydicarbonates, monoperoxycarbonates, peroxyketals, peroxyesters, dialkyl peroxides, hydroperoxides, or combinations thereof. The initiator may be present in an amount of from 0.2 wt. % to 3 wt. % based on the weight of the acrylate containing compound. The blend may further comprise a tackifier. The tackifier may comprise an alkylphenolic, a coumarone-indene, an aliphatic hydrocarbon, a cycloaliphatic hydrocarbon, an aromatic hydrocarbon resin, a rosin, an aromatically modified aliphatic hydrocarbon and hydrogenated derivatives thereof; an aromatically modified cycloaliphatic hydrocarbon and hydrogenated derivatives thereof, polyterpene, styrenated polyterpene, or combinations thereof. The blend may further comprise a processing oil. The processing oil may comprise a mineral oil. The one or more substrates may comprise paper, corrugated board, chip board, cardstock films, metal, plastics, glass, wood, leather and textile materials, filmic materials, polyolefins, polystyrenes, polyamides, polyesters, plasticized polyesters, acrylonitrile copolymers, styrene-butadiene copolymers, polyvinyl chloride (PVC), polycarbonate, rubber, or combinations thereof. The two or more substrates may be adhered to form a multilayer article. The substrates that are adhered may comprise polyolefin-to-polyolefin substrates, polyolefin-to-polyvinyl chloride substrates, polyolefin-to-wood substrates, polyolefin-to-metal substrates, polyolefin-to-nylon substrates, polyolefin-to-polystyrene substrates, and polyolefin-to-rubber substrates. The blend may crosslink to the substrate. The blend may have a melt flow rate of from 10 g/10 min. to 50,000 g/10 min.

Also disclosed herein is a method comprising extruding a metallocene ethylene-propylene random copolymer to form a melt, wherein the copolymer has a melt flow rate of from 0.5 g/10 min. to 2000 g/10 min., and applying the melt to one or more substrates.

Also disclosed herein is a method comprising reactively extruding a metallocene ethylene-propylene random copolymer, an acrylate containing compound, and a peroxide to form a polyolefin/polyacrylate blend, wherein the blend has a melt flow rate of greater than 100 g/10 min.; and applying the blend in a melted form to one or more substrates.

Also disclosed herein is a hot melt adhesive prepared according to the methodologies disclosed.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are polymeric compositions for use as hot melt adhesives (HMAs). In an embodiment, the polymeric compositions comprise a metallocene resin (MR). Alternatively, the polymeric composition comprises a polyolefin/polyacrylate blend (POPA), for example a metallocene resin and polyacrylate blend. Such polymeric compositions may be melted and applied to one or more substrates to adhere same.

In an embodiment, the HMA comprises a metallocene resin (MR), alternatively a metallocene polypropylene (mPP). The mPP may be a homopolymer or a copolymer, for example a copolymer of propylene with one or more alpha olefin monomers such as ethylene, butene, hexene, etc.

In an embodiment, the mPP comprises a syndiotactic polypropylene (sPP). A polymer is “syndiotactic” when its pendant groups alternate on opposite sides of the chain; “atactic” when its pendant groups are arranged in a random fashion on both sides of the chain of the polymer; and “isotactic” when all of its pendant groups are arranged on the same side of the chain. In a hemi-isotactic polymer, every other repeat unit has a random substituent. The ethylene units do not have a tacticity as they do not have any pendant units, just four hydrogen (H) atoms attached to a carbon backbone (C—C).

The sPP may be a homopolymer or a copolymer. In an embodiment, the sPP may have a melt flow rate (MFR) or melt mass flow rate of from 0.5 g/10 min. to 1000 g/10 min., alternatively from 1 g/10 min. to 500 g/10 min., and alternatively from 2 g/10 min. to 100 g/10 min. As defined herein, the MFR refers to the quantity of a melted polymer resin that will flow through an orifice at a specified temperature and under a specified load. The MFR may be determined using a dead-weight piston Plastometer that extrudes a polymer through an orifice of specified dimensions at a temperature of 230° C., and a load of 2.16 kg in accordance with ASTM D-1238 condition “L”.

Examples of sPPs suitable for use in this disclosure include without limitation FINAPLAS 1251, FINAPLAS 1471, and FINAPLAS 1571 copolymer syndiotactic polypropylenes, which are commercially available from Total Petrochemicals USA, Inc. In an embodiment, the syndiotactic polypropylene (e.g., FINAPLAS 1251) generally has the physical properties set forth in Table 1.

TABLE 1

| | |
|---|---|
| Typical Value | ASTM Method |

Resin Properties

| | | |
|---|---|---|
| Melt Flow, g/10 min. | 11 | D 1238 |
| Density, g/cc | 0.895 | D 1505 |
| Melting Point⁽²⁾, ° F. (° C.) | 266 (130) | DSC⁽¹⁾ |

Film Properties Non-oriented- 2 mil (50 μm)

| | | |
|---|---|---|
| Haze, % | 6.9 | D 1003 |
| Yellow Index | −3.7% | D 1925 |
| Ultimate Tensile Strength, psi (MPa) | 2,200 (15.2) | D 638 |
| Elongation at Break (%) | 250 | D 790 |
| Elongation at Yield (%) | 11 | D 790 |
| Tensile Modulus, kpsi (GPa) | 70 (0.483) | D 638 |
| Flexural Modulus, kpsi (GPa) | 50 (0.345) | D 638 |
| Izod Impact, Notched, ft-lb/in | 12 | D 256A |

⁽¹⁾MP determined with a DSC-2 Differential Scanning Calorimeter.

In an embodiment, the mPP is a random ethylene-propylene (C₂/C₃) copolymer (mREPC) and may comprise from 1 wt. % to 10 wt. % ethylene, alternatively from 3 wt. % to 7 wt. % ethylene alternatively from 3 wt. % to 6 wt. % ethylene, alternatively from 4 wt. % to 6.5 wt. % ethylene, alternatively from 5.5 wt. % to 6.5 wt. % ethylene, alternatively from 5.8 wt. % to 6.2 wt. % ethylene, alternatively 6 wt. % ethylene. The mREPC may have a melting point temperature of from 100° C. to 155° C., alternatively from 110° C. to 148° C., alternatively from 115° C. to 121° C. Furthermore, the mREPC may have a molecular weight distribution of from 1 to 8, alternatively from 2 to 6, alternatively from 3 to 5. The melting point range is indicative of the degree of crystallinity of the polymer while the molecular weight distribution refers to the relation between the number of molecules in a polymer and their individual chain length.

In ethylene-propylene random copolymers, the ethylene molecules are inserted randomly into the polymer backbone between repeating propylene molecules, hence the term random copolymer. In the preparation of a mREPC a certain amount of amorphous polymer is produced. This amorphous or atactic polymer is soluble in xylene and is thus termed the xylene soluble fraction or percent xylene solubles (XS %). In determining XS %, the polymer is dissolved in hot xylene and then the solution is cooled to 0° C. which results in the precipitation of the isotactic or crystalline portion of the polymer. The XS % is that portion of the original amount that remained soluble in the cold xylene. Consequently, the XS % in the polymer is further indicative of the extent of crystalline polymer formed. In an embodiment, the mREPC has a xylene soluble fraction of from 0.1% to 6.0%; alternatively from 0.2% to 2.0%; and alternatively from 0.3% to 1.0%, as determined in accordance with ASTM D 5492-98.

In an embodiment, an mREPC suitable for use in this disclosure may have a density of from 0.890 g/cc to 0.920 g/cc, alternatively from 0.895 g/cc to 0.915 g/cc, and alternatively from 0.900 g/cc to 0.910 g/cc as determined in accordance with ASTM D-1505. In an embodiment, an mREPC suitable for use in this disclosure may have a melt flow rate of from 0.5 g/10 min. to 2000 g/10 min., alternatively from 1 g/10 min. to 1000 g/10 min., and alternatively from 10 g/10 min. to 500 g/10 min, as determined in accordance with ASTM D-1238 condition “L”. In an embodiment, a film prepared from an mREPC suitable for use in this disclosure may have a gloss at 45° of from 70 to 95, alternatively from 75 to 90, and alternatively from 80 to 90 as determined in accordance with ASTM D-2457.

An example of a suitable mREPC includes without limitation a metallocene catalyzed ethylene-propylene random copolymer known as EOD 02-15 available from Total Petrochemicals USA, Inc. In an embodiment, the mREPC (e.g., EOD 02-15) generally has the physical properties set forth in Table 2.

TABLE 2

| | |
|---|---|
| Typical Value | ASTM Method |

Resin Properties

| | | |
|---|---|---|
| Melt Flow, g/10 min. | 11 | D 1238 |
| Density, g/cc | 0.895 | D 1505 |
| Melting Point, ° F. (° C.) | 246 (119) | DSC ⁽¹⁾ |

Film Properties ⁽¹⁾ Non-oriented- 2 mil (50 μm)

| | | |
|---|---|---|
| Haze, % | 0.3 | D 1003 |
| Gloss @ 45°, % | 90 | D 2457 |
| 1% Secant Modulus (MD), psi (MPa) | 50,000 (345) | D 882 |
| Ultimate Tensile Strength (MD), psi (MPa) | 5,000 (35) | D 882 |
| Ultimate Elongation (MD), % | 700 | D 882 |
| Heat Seal Temperature ⁽²⁾, ° F. (° C.) | 221 (105) | |

⁽¹⁾ MP determined with a DSC-2 Differential Scanning Calorimeter.
⁽²⁾ Seal condition: die pressure 60 psi (413 kPa), dwell time 1.0 sec

The mREPC may be formed by placing propylene in combination with ethylene in a suitable reaction vessel in the presence of a metallocene catalyst and under suitable reaction conditions for polymerization thereof. Ethylene-propylene random copolymers may be prepared through the use of metallocene catalysts of the type disclosed and described in further detail in U.S. Pat. Nos. 5,158,920, 5,416,228, 5,789,502, 5,807,800, 5,968,864, 6,225,251, and 6,432,860, each of which are incorporated herein by reference.

Metallocene resins described herein, e.g., mREPC and/or syndiotactic mPP, may be used alone as HMAs, or may be combined with other components to form blends that may be used as HMAs.

In an embodiment, the HMA comprises a POPA blend, for example a blend of mREPC and polyacrylate or alternatively a blend of syndiotactic mPP and polyacrylate. The POPA blend may be prepared by reactive extrusion of a mixture comprising a polyolefin, an acrylate containing compound, and an initiator.

In an embodiment, the POPA blend comprises a polyolefin. The blend may include a polyolefin of the type described previously herein. For example, a polyolefin suitable for use in this disclosure may be any polyolefin having a MFR of from 0.5 g/10 min. to 2000 g/10 min.; alternatively from 1 g/10 min. to 1000 g/10 min.; and alternatively from 10 g/10 min. to 500 g/10 min., as determined in accordance with ASTM D-1238 condition “L”. Examples of resins suitable for use in this disclosure include without limitation polypropylene and polyethylene. Such polyolefins may be employed as homopolymers, alternatively the polyolefin may comprise a copolymer.

In an embodiment, the polyolefin comprises a metallocene resin, alternatively a metallocene polypropylene. The metallocene polypropylene may be a random ethylene propylene copolymer of the type previously described herein.

In an alternative embodiment, the polyolefin comprises a polypropylene homopolymer. Polypropylene homopolymers suitable for use in this disclosure may include any type of polypropylene known in the art. For example, the polypropylene homopolymer may be atactic polypropylene, isotactic polypropylene, hemi-isotactic polypropylene, syndiotactic polypropylene, or combinations thereof. In an embodiment, the polyolefin comprises a sPP of the type previously described herein.

In an embodiment, a polypropylene (e.g., homopolymer and/or copolymer) suitable for use in this disclosure may have a melting temperature of from 80° C. to 170° C., alternatively from 90° C. to 168° C., and alternatively from 100° C. to 165° C. as determined by differential scanning calorimetry; a melt flow rate of from 0.5 g/10 min. to 1000 g/10 min., alternatively from 1.0 g/10 min. to 500 g/10 min., and alternatively from 1.5 g/10 min. to 200 g/10 min. as determined in accordance with ASTM D-1238 condition “L”.

Examples of polypropylene homopolymers suitable for use in this disclosure include without limitation 3371, 3271, 3270, and 3276, which are polypropylene homopolymers commercially available from Total Petrochemicals USA, Inc. In an embodiment, the polypropylene homopolymer (e.g., 3371) has generally the physical properties set forth in Table 3.

TABLE 3

| | |
|---|---|
| 3371 | |
| Typical Value | Test Method |

Physical Properties

| | | |
|---|---|---|
| Density, g/cc | 0.905 | ASTM D-1505 |
| Melt Flow Rate (MFR), g/10 min. | 2.8 | ASTM D-1238 condition “L” |

Mechanical Properties

| | | |
|---|---|---|
| Tensile Modulus, psi | 235,000 | ASTM D-638 |
| Tensile Stress at Yield, psi | 5,100 | ASTM D-638 |
| Tensile Strain at Yield, % | 7.5 | ASTM D-638 |
| Flexural Modulus, psi | 202,000 | ASTM D-790 |

Impact Properties

| | | |
|---|---|---|
| Gardner impact, in-lb | 149.2 | ASTM D-2463 |
| Notched Izod Impact Strength, ft lb/in | 0.69 | ASTM D-256A |

Hardness

| | | |
|---|---|---|
| Hardness Shore D | 75 | ASTM D-2240 |

Thermal Properties

| | | |
|---|---|---|
| Heat distortion temperature, ° F. | 207 | ASTM D-648 |
| Melting Temperature (DSC), ° F. | 325 | DSC |

In another embodiment, the polypropylene may be a high crystallinity polypropylene homopolymer (HCPP). The HCPP may contain primarily isotactic polypropylene. The isotacticity in polymers may be measured via ¹³C NMR spectroscopy using meso pentads and can be expressed as percentage of meso pentads (% mmmm). As used herein, the term “meso pentads” refers to successive methyl groups located on the same side of the polymer chain. In an embodiment, the HCPP has a meso pentads percentage of greater than 97%, or greater than 98%, or greater than 99%. In an embodiment, the HCPP has a xylene soluble fraction of less than 1.5%, or less than 1.0%, or less than 0.5% as determined in accordance with ASTM D 5492-98.

In an embodiment, an HCPP suitable for use in this disclosure may have a MFR of from 0.5 g/10 min. to 1000 g/10 min., alternatively from 1.0 g/10 min. to 500 g/10 min., and alternatively from 1.5 g/10 min. to 200 g/10 min. as determined in accordance with ASTM D-1238; and a melting temperature of from 150° C. to 170° C., alternatively from 155° C. to 170° C., and alternatively from 160° C. to 170° C. as determined by differential scanning calorimetry.

An example of an HCPP suitable for use in this disclosure includes without limitation 3270, which is an HCPP commercially available from Total Petrochemicals USA, Inc. The HCPP (e.g., 3270) may generally have the physical properties set forth in Table 4.

TABLE 4

| | |
|---|---|
| 3270 | |
| Typical Value | Test Method |

Physical Properties

| | | |
|---|---|---|
| Density, g/cc | 0.910 | ASTM D1505 |
| Melt Mass-Flow Rate (MFR) | 2.0 | ASTM D1238 |
| (230° C./2.16 kg), g/10 min. | | |

BOPP Mechanical Properties

| | | |
|---|---|---|
| Secant Modulus MD, psi | 420,000 | ASTM 882 |
| Secant Modulus TD, psi | 700,000 | ASTM 882 |
| Tensile Strength at Break MD, psi | 28,000 | ASTM 882 |
| Tensile Strength at Break TD, psi | 39,000 | ASTM 882 |
| Elongation at Break MD, % | 150 | ASTM 882 |
| Elongation at Break TD, % | 60 | ASTM 882 |

Thermal Properties

| | | |
|---|---|---|
| Melting Temperature, ° F. | 329 | DSC |

Optical Properties

| | | |
|---|---|---|
| Gloss (45°) | 85 | ASTM D2457 |
| Haze, % | 1.0 | ASTM D1003 |

Additional Properties

| | | |
|---|---|---|
| Water Vapor Transmission, 100° F., | 0.2 | ASTM F1249-90 |
| 90% R.H, g-mil/100 in²/day | | |

In an embodiment, the POPA comprises polyethylene, alternatively high density polyethylene, alternatively low density polyethylene, alternatively linear low density polyethylene.

In an embodiment, the POPA comprises high density polyethylene (HDPE). The HDPE may be a homopolymer or a copolymer, for example a copolymer of ethylene with one or more alpha-olefin monomers such as propylene, butene, hexene, etc. In an embodiment, the HDPE is a homopolymer. An HDPE suitable for use in this disclosure may generally have a melt-mass flow rate, determined by ASTM D1238, of from 0.1 g/10 min to 500 g/10 min or from 0.5 g/10 min to 200 g/10 min or from 1 g/10 min to 100 g/10 min. In an embodiment, a HDPE suitable for use in this disclosure may generally have a tensile modulus, determined by ASTM D638, of from 100,000 psi to 350,000 psi or from 150,000 psi to 300,000 psi, or from 180,000 psi to 220,000 psi. In an embodiment, a HDPE suitable for use in this disclosure may generally have a flexural modulus, determined by ASTM D790, of from 30,000 psi to 350,000 psi, or from 100,000 psi to 300,000 psi, or from 150,000 psi to 200,000 psi. In an embodiment, a HDPE suitable for use in this disclosure may generally have a melting temperature, determined by differential scanning calorimetry (DSC), of from 120° C. to 140° C., or from 125° C. to 135° C., or from 130° C. to 133° C.

Examples of HDPEs suitable for use in this disclosure include without limitation 6450 HDPE which is a polyethylene resin and mPE ER 2283 POLYETHYLENE which is a metallocene high density polyethylene resin with hexene as comonomer, both are commercially available from Total Petrochemicals USA, Inc. In an embodiment, a suitable HDPE has generally the physical properties set forth in Table 5 (e.g., 6450 HDEP) or Table 6 (e.g., ER 2283).

TABLE 5

| | | |
|---|---|---|
| Properties | Typical Value | ASTM Method |

Resin Properties⁽¹⁾

| | | |
|---|---|---|
| Melt Flow Index, g/10 min | | D 1238 |
| 190° C./2.16 kg | 5.0 | |
| Density, g/cm³ | 0.962 | D 792 |
| Melting Point, ° F. | 265 | D 3417 |

Film Properties⁽¹⁾⁽²⁾

| | | |
|---|---|---|
| Haze, % | 5.0 | D 1003 |
| Gloss, % | 85 | D 523 |
| Tensile Strength @ Break, psi | | D 882 |
| MD | 3500 | |
| TD | 3800 | |
| Elongation @ Break, % | | D 882 |
| MD | 850 | |
| TD | 650 | |
| Secant Modulus @ 2% Strain, psi | | D 882 |
| MD | 100,000 | |
| TD | 130,000 | |
| WVTR⁽³⁾ @ 100° F., g/100 in²/day | 0.5 | E 96/66 |
| Low Temp. Brittleness, ° F. | <−112 | D 746 |

⁽¹⁾Data developed under laboratory conditions and are not to be used as specification, maxima or minima.
⁽²⁾The data listed were determined on 1.0 mil cast film.
⁽³⁾Water Vapor Transmission Rate.

TABLE 6

| | | | |
|---|---|---|---|
| Properties | Method | Unit | Value |

Physical Properties

| | | | |
|---|---|---|---|
| Density | ISO 1183 | g/cm³ | 0.950 |
| Melt Index (2.16 kg) | ISO 1133 | g/10 min | 2.0 |
| Melting Point | EN ISO 11357 | ° C. | 133 |
| Vicat Temperature | ISO 306 | ° C. | 130 |

Cast Film Properties

| | | | |
|---|---|---|---|
| Dart Impact | ISO 7765-1 | g | 36 |
| Tensile Strength at Yield MD/TD | ISO 527-3 | MPa | 23/24 |
| Tensile Strength at Break MD/TD | ISO 527-3 | MPa | 43/41 |
| Elongation at Break MD/TD | ISO 527-3 | % | 640/820 |
| Elmendorf MD/TD | ISO 6393 | N/mm | 8/130 |
| Haze | ISO 14782 | % | 10 |
| Gloss 45° | ASTM D 2457 | | 68 |

In an embodiment, the POPA comprises a low density polyethylene (LDPE). Herein an LDPE is defined as having a density range of from 0.910 g/cm³ to 0.940 g/cm³, alternatively from 0.917 g/cm³ to 0.935 g/cm³, and alternatively from 0.920 g/cm³ to 0.930 g/cm³. The LDPE may be further characterized by the presence of increased branching when compared to a HDPE. The LDPE may be a homopolymer or a copolymer, for example a copolymer of ethylene with one or more alpha-olefin monomers such as propylene, butene, hexene, etc. In an embodiment, the LDPE is a homopolymer. An LDPE suitable for use in this disclosure may generally have a melt-mass flow rate, determined by ASTM D1238, of from 0.1 g/10 min. to 500 g/10 min. or from 0.5 g/10 min. to 200 g/10 min. or from 1.0 g/10 min. to 100 g/10 min. In an embodiment, a LDPE suitable for use in this disclosure may generally have a tensile modulus, determined by ASTM D638, of from 10,000 psi to 70,000 psi or from 15,000 psi to 65,000 psi, or from 20,000 psi to 60,000 psi. In an embodiment, a LDPE suitable for use in this disclosure may generally have a flexural modulus, determined by ASTM D790, of from 9,000 psi to 60,000 psi, or from 10,000 psi to 55,000 psi, or from 15,000 psi to 50,000 psi. In an embodiment, a LDPE suitable for use in this disclosure may generally have a melting temperature, determined by differential scanning calorimetry (DSC), of from 85° C. to 125° C., or from 90° C. to 120° C., or from 95° C. to 120° C.

A representative example of a suitable LDPE is Total Petrochemical LDPE 1020 FN 24 with a melt index of 2.1 g/10 min (190° C./2.16 kg). In an embodiment, a suitable LDPE has generally the physical properties set forth in Table 7 (e.g., LDPE 1020 FN 24).

TABLE 7

| | | |
|---|---|---|
| English | SI | Method |

Nominal Resin Properties

| | | | |
|---|---|---|---|
| Density | — | 0.922 g/cm³ | ASTM D1505 |
| Melt Index, 190 C./2.16 Kg | — | 2.1 g/10 min | ASTM D1238 |
| Melting Point | 232° F. | 109° C. | ASTM D3418 |
| Vicat Softening Temperature | 209° F. | 94° C. | ASTM D1525 |

Nominal Blown Film Properties at 40 um⁽¹⁾

| | | | |
|---|---|---|---|
| Haze | 7.0% | 7.0% | ASTM D1003 |
| Tensile Strength at Yield MD/TD | 1595 psi/1523 psi | 11 MPa/10.5 MPa | ISO 527-3 |
| Tensile Strength at Break MD/TD | 4061 psi/3190 psi | 28/22 MPa | ISO 527-3 |
| Elongation at Break MD/TD | 360%/630% | 360%/630% | ISO 527-3 |
| Elmendorf MD/TD | — | 75/45N/mm | ISO 6383-2 |
| Dart test | — | 120 g | ISO 7765-1 |
| Haze | 7% | 7% | ISO 14782 |

⁽¹⁾Data are obtained using laboratory test specimens produced with the following extrusion conditions: 45 mm screw diameter, L/D = 30, die diameter = 120 mm, die gap = 1.4 mm, BUR = 2.5:1, temperature = 185° C.

In an embodiment, the POPA comprises a linear low density polyethylene (LLDPE). LLDPE is a substantially linear polyethylene with a significant number of short branches. LLDPE is commonly generated by the copolymerization of ethylene with longer chain olefins. LLDPE differs structurally from low-density polyethylene because of the absence of long chain branching. In an embodiment, the LLDPE is a copolymer, for example a copolymer of ethylene with one or more alpha-olefin monomers such as propylene, butene, hexene, etc. An LLDPE suitable for use in this disclosure may generally have a density, determined by ASTM D1505, of from 0.870 g/cm³ to 0.930 g/cm³, or from 0.900 g/cm³ to 0.930 g/cm³, or from 0.910 g/cm³ to 0.925 g/cm³. In an embodiment, an LLDPE suitable for use in this disclosure may generally have a melt-mass flow rate, determined by ASTM D1238, of from 0.1 g/10 min. to 500 g/min., or from 0.5 g/10 min. to 200 g/10 min., or from 1 g/10 min. to 100 g/10 min. In an embodiment, an LLDPE suitable for use in this disclosure may generally have a tensile modulus, determined by ASTM D638, of from 20,000 psi to 250,000 psi, or from 50,000 psi to 220,000 psi, or from 100,000 psi to 200,000 psi. In an embodiment, an LLDPE suitable for use in this disclosure may generally have a flexural modulus, determined by ASTM D790, of from 5,000 psi to 150,000 psi, or from 10,000 psi to 130,000 psi, or from 50,000 psi to 110,000 psi. In an embodiment, an LLDPE suitable for use in this disclosure may generally have a melting temperature, determined by differential scanning calorimetry (DSC), of from 70° C. to 140° C., or from 80° C. to 130° C., or from 90° C. to 120° C.

A representative example of a suitable LLDPE is FINATHENE LL 4010 FE 18, which is an LLDPE commercially available from Total Petrochemicals. The LLDPE (e.g., FINATHENE LL 4010 FE 18) may generally have the physical properties set forth in Table 8.

TABLE 8

| | | |
|---|---|---|
| English | SI | Method |

Nominal Resin Properties

| | | | | |
|---|---|---|---|---|
| Density | — | 0.918 | g/cm³ | ASTM D792 |

| | | | |
|---|---|---|---|
| Melt Index | — | 1.0 g/10 min | ASTM D1238 |

Nominal Film Properties at 0.984 mil (25 um)⁽¹⁾

| Film Tensile Strength at Yield, MD | 1600 | psi | 11.0 | MPa | ISO 527 |
|---|---|---|---|---|---|
| Film Tensile Strength at Yield,, TD | 1600 | psi | 11.0 | MPa | ISO 527 |
| Film Elongation at Break, MD | 600% | | 600% | | ISO 527 |
| Film Elongation at Break, TD | 750% | | 750% | | ISO 527 |
| Secant Modulus, MD | 23.2 | ksi | 0.160 | GPa | ISO 5527 |
| Secant Modulus, TD | 24.7 | ksi | 0.170 | GPa | ISO 5527 |
| Dart Drop Test | 0.198 | lb | 90.0 | g | ISO 7765-1 |
| Film Tensile Strength at Break, MD | 5800 | psi | 40.0 | MPa | ISO 527 |
| Film Tensile Strength at Break, TD | 4350 | psi | 30.0 | MPa | ISO 527 |

Thermal Properties

| | | | | | |
|---|---|---|---|---|---|
| Melting Point | 252° | F. | 122° | C. | ISO 11357-3 |

Optical Properties

| | | | |
|---|---|---|---|
| Haze | 10.0% | 10.0% | ASTM D 1003 |

In an embodiment, the POPA blend comprises from 50 wt. % to 99.8 wt. %, alternatively from 60 wt. % to 95 wt. %, and alternatively from 60 wt. % to 90 wt. % of a polyolefin based on the total weight of the blend.

In an embodiment, the POPA comprises polyacrylate and may be formed for example by the mixing of a polyacrylate and a polyolefin. The mixing of the polyolefin and polyacrylate may be carried out using any suitable methodology.

In an embodiment, the POPA comprises polyacrylate and is formed by polymerization of an acrylate containing compound with the polyolefin. The acrylate containing compound may be any compound compatible with the other components of the HMA and able to provide or form an acrylate monomer that may further form in situ a polyacrylate when blended with a polyolefin, for example under reactive extrusion conditions to be described later herein. In an embodiment, the acrylate containing compound is an acrylate monomer, alternatively a functionalized acrylate monomer. Herein a functionalized acrylate monomer refers to an acrylate monomer comprising one or more chemical functionalities which may serve to enhance the adherence of the HMA to the substrate and/or to increase the adherence of the substrates which are bound together by the HMA. The specificity of the HMA for a particular substrate may be enhanced by the choice of an acrylate containing compound having one or more functionalities that increase the compatibility of the HMA with the substrate. For example, an acrylate containing compound may comprise one or more polar groups which may result in the HMA having increased compatibility with polar substrates. Further, the acrylate containing compound may comprise one or more functional groups which may react further with the substrate to increase adherence of the HMA to the substrate and or increase the strength of adhesion between two or more substrates bound by the HMA. For example, the functional groups may react further to crosslink the HMA and substrate. This additional crosslinking may result in a number of improved mechanical properties which will be described in more detail later herein.

In an embodiment, the acrylate containing compound comprises a monoacrylate, a diacrylate, a triacrylate, or combinations thereof. The acrylate containing compound may be further functionalized or modified. In an embodiment, the acrylate containing compound comprises an acrylic ester, an alkoxylated nonylphenol acrylate, a metallic diacrylate, a modified metallic diacrylate, a trifunctional acrylate ester, a trifunctional methacrylate ester, ethoxylated trimethylolpropane triacrylate, propoxylated glycerol triacrylate, tripropylene glycol diacrylate, 2-(2-ethoxyethoxy)ethyl acrylate, ethoxylated (15) trimethylolpropane triacrylate, ethoxylated (30) bisphenol A diacrylate, ethoxylated (30) bisphenol A dimethacrylate, ethoxylated (20) trimethylolpropane triacrylate, methoxy polyethylene glycol (350) monoacrylate, methoxy polyethylene glycol (350) monomethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol monomethacrylate, 1,12-dodecanediol methacrylate, 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, acrylate ester, alkoxylated aliphatic diacrylate, alkoxylated cyclohexane dimethanol diacrylate, alkoxylated hexanediol diacrylate, alkoxylated neopentyl glycol diacrylate, cyclohexane dimethanol diacrylate, diethylene glycol diacrylate, diethylene glycol dimethacrylate, dipropylene glycol diacrylate, ethoxylated (10) bisphenol A diacrylate, ethoxylated (2) bisphenol A dimethacrylate, ethoxylated (3) bisphenol A diacrylate, ethoxylated (4) bisphenol A diacrylate, ethoxylated (4) bisphenol A dimethacrylate, ethoxylated (8) bisphenol A dimethacrylate, ethoxylated bisphenol A dimethacrylate, ethoxylated (10) bisphenol dimethacrylate, ethoxylated (6) bisphenol A dimethacrylate, ethylene glycol dimethacrylate, neopentyl glycol diacrylate, nenopentyl glycol dimethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol (1000) dimethacrylate, polyethylene glycol dimethacrylate, polypropylene glycol (400) dimethacrylate, propoxylated (2) neopentyl glycol diacrylate, tetraethylene glycol diacrylate, tetraethylene glycol dimethacrylate, tricyclodecane dimethanol diacrylate, triethylene glycol diacrylate, or combinations thereof.

In an embodiment, a mixture for preparation of a POPA comprises an acrylate containing compound in an amount of from 0.2 wt. % to 50 wt. %, alternatively from 0.5 wt. % to 40 wt. %, and alternatively from 1 wt. % to 30 wt. %, based on the total weight of the final blend.

In an embodiment, a mixture for the preparation of a POPA comprises an initiator, which may polymerize the acrylate containing compound to form the POPA blend. Any initiator capable of free radical formation that facilitates the polymerization of the acrylate may be employed. Such initiators include by way of example and without limitation organic peroxides. Examples of organic peroxides useful for polymerization initiation include without limitation benzoyl peroxide, lauroyl peroxide, t-butyl peroxybenzoate, 1,1-di-t-butylperoxy-2,4-di-t-butylcyclohexane, diacyl peroxides, peroxydicarbonates, monoperoxycarbonates, peroxyketals, peroxyesters, dialkyl peroxides, hydroperoxides, or combinations thereof. The selection of initiator and effective amount will depend on numerous factors (e.g., temperature, reaction time) and can be chosen by one skilled in the art with the benefits of this disclosure to meet the needs of the process. For example, the initiator may be present in a reaction mixture in an amount of from 0.1 wt. % to 5 wt. %, alternatively from 0.2 wt. % to 3 wt. %, alternatively from 0.3 wt. % to 2 wt. %, based upon the weight of the acrylate containing compound. Polymerization initiators and their effective amounts have been described in U.S. Pat. Nos. 6,822,046; 4,861,127; 5,559,162; 4,433,099; and 7,179,873, each of which are incorporated by reference herein in their entirety. Examples of initiators suitable for use in this disclosure include LUPERSOL 101, which is 2,5-dimethyl-2,5-di-(tert-butylperoxy)hexane commercially available from Arkema, and TRIGANOX 301, which is 3,6,9-Triethyl-3,6,9-trimethyl-1,4,7-triperoxonane commercially available from Azko Nobel.

In an embodiment, the POPA may further comprise one or more additives to impart desired physical properties, such as printability, increased gloss, or a reduced blocking tendency. Examples of such additives include, without limitation, stabilizers, ultra-violet screening agents, oxidants, anti-oxidants, anti-static agents, ultraviolet light absorbents, fire retardants, processing oils, mold release agents, coloring agents, pigments/dyes, fillers, blowing agents, fluorescing agent, surfactant, tackifiers, processing oils, and/or other suitable additives. The aforementioned additives may be used either singularly or in combination to form various formulations of the polymer. For example, stabilizers or stabilization agents may be employed to help protect the polymer resin from degradation due to exposure to excessive temperatures and/or ultraviolet light.

In some embodiments, the POPA comprises tackifiers, processing oils, or other materials that may improve the adhesive properties and/or processability of the POPA. An example of a suitable processing oil includes without limitation mineral oil.

Tackifiers are additives that are used to improve the initial adhesive strength or tack on contact with an adherend surface before a stronger bond is formed later upon cooling. The tackifier may also function to reduce the viscosity and elasticity of the polymer molecules of the hot melt adhesive thereby allowing better wetting of the adherend surfaces. Examples of tackifiers suitable for use in this disclosure include, without limitation, alkylphenolics such as P-133 RESIN commercially available from Akrochem, coumarone indenes such as CUMAR P-10 commercially available from Neville; aliphatic and cycloaliphatic hydrocarbons such as KRISTALEX F115; aromatic hydrocarbon resins such as PICCO 6115; rosins such as DRESINATE NVX; aromatically modified aliphatic hydrocarbons, aromatically modified cycloaliphatic hydrocarbon, hydrogenated derivatives thereof; polyterpene, styrenated polyterpene, or combinations thereof. KRISTALEX F115, PICCO 6115 and DRESINATE NVX are all available from Eastman Chemical Company. In alternative embodiment, the HMAs are substantially free of tackifiers as will be described in more detail later herein.

These additives may be included in amounts effective to impart the desired properties. Effective additive amounts and processes for inclusion of these additives to polymeric compositions may be determined by one skilled in the art with the aid of this disclosure. For example, the additives may be present in an amount of from 0.1 wt. % to 50 wt. %, alternatively from 1 wt. % to 40 wt. %, alternatively from 2 wt. % to 30 wt. % based on the total weight of the blend.

In an embodiment, a POPA may be prepared by contacting a polyolefin, an acrylate containing compound, and an initiator, each of the type described previously herein, under conditions suitable for the formation of a polymeric blend. For example, the components of the POPA may be subjected to reactive extrusion wherein the components are dry blended, fed into an extruder, and melted inside the extruder. The mixing may be carried out using a continuous mixer such as for example a mixer consisting of an intermeshing co-rotating twin screw extruder for mixing/melting the components of the POPA and a single screw extruder or a gear pump for pumping.

In an embodiment, the POPA has a melt flow rate that is increased relative to that of the base resin. For example, the POPA may have a melt flow rate of from 10 g/10 min. to 50,000 g/10 min., alternatively from 50 g/10 min. to 30,000 g/10 min., and alternatively from 100 g/10 min. to 10,000 g/10 min.

The adhesive compositions of this disclosure (e.g., a POPA blend, a MR alone, etc.) can be used as hot melt adhesives to bond one or more substrates. For example, the HMAs may be melted and then applied to one or more substrates. In an embodiment, the HMA may be applied to a substrate by being extruded onto the surface of the substrate, while in the melt phase, and then contacted with another surface which is a second substrate or with a second surface of the same substrate. In an embodiment, the adhesive compositions of this disclosure may be used to adhere multiple substrates together to form multilayer articles such as a multilayer film or sheet. The HMAs may be applied to the substrates by any suitable means (e.g., co-extrusion, melt guns, tack guns, etc.) and in any suitable pattern (e.g., substantially continuous or discontinuous layers, lines, waves, dots, etc.). The HMAs may be applied about contemporaneously with being formed (e.g., on the same line downstream of the reactive extrusion to form the HMA), wherein the HMA remains in a molten state after being formed and then applied to one or more substrates. Alternatively, the HMAs may be formed and shaped (e.g., pelletized) for storage and/or shipment and subsequent use, for example by melting and application by an end use manufacturer of goods.

The adhesive compositions of this disclosure may be used to adhere one or more substrates that may be the same or different to each other and/or to themselves. Suitable substrates include, but are not limited to, paper, corrugated board, chip board, cardstock films, metal, plastics, glass, wood, leather and textile materials, and filmic materials. In an embodiment, the substrates may be composed of plastics, such as, polyolefin, polystyrene, polyamide, polyester, plasticized polyester, acrylonitrile copolymers, styrene-butadiene copolymers, polyvinyl chloride (PVC), polycarbonate polycarbonate, rubber, or combinations thereof. In another embodiment, the adhesive composition of this disclosure may be used to adhere to a combination of substrates. Examples of combinations of substrates that may be adhered together with the HMAs of this disclosure include, without limitation, polyolefin-to-polyolefin, polyolefin-to-PVC, polyolefin-to-wood, polyolefin-to-metal, polyolefin-to-nylon, polyolefin-to-polystyrene, and polyolefin-to-rubber.

In an embodiment, the compositions of this disclosure function as an adhesive that is applied to a first substrate, which is simultaneously or subsequently contacted with a second substrate. For example, the HMA may be coextruded between two substrates, or may be extruded or coextruded onto one substrate and subsequently contacted with a second substrate in a processing line. The second substrate may function as a protective cover to prevent and/or inhibit the first substrate and adhesive from contact with other materials. This protective cover may be removed at some later point in time and at least a portion of the hot melt adhesive remain adhered to the first substrate. In such embodiments, the now unprotected first substrate and adhesive may be adhered to a third substrate by the contacting of the first and third substrate and the application of heat and/or pressure. Thus, the adhesive formulations disclosed herein may be adjusted by one of ordinary skill of the art with the benefits of this disclosure to function as heat and/or pressure sensitive adhesives. The compositions of this disclosure may thus be utilized in production of ostomy seals, adhesive tapes and bandages, wound drainage adhesive seals, wound dressings, as adherents for other products and the like that adhere to human skin and remain adherent even in a moist environment. In an embodiment, the compositions of this disclosure are utilized as pressure sensitive adhesives which may be incorporated into a transdermal drug delivery device designed to deliver a therapeutically effective amount of a product to the skin of an organism, e.g., to cure a skin irritation or to deliver a therapeutically effective amount of drug across the skin of an organism.

The compositions of this disclosure may function as hot melt adhesives that adhere to surfaces of a variety of similar or dissimilar substrates. In an embodiment, the compositions of this disclosure may function as HMAs in the absence of additives commonly employed in hot melt adhesive formulations, for example in the absence of tackifiers (e.g., the HMAs may be substantially free of tackifiers). The hot melt adhesives of this disclosure may be characterized by a high tack strength and the ability to promote surface wetting, adhesion, and adhesive flexibility in the absence of tackifiers.

In an embodiment, the acrylate containing compound may be chosen to provide one or more additional chemical functionalities that result in the crosslinking of the HMA to one or more substrates and reducing the tendency of the HMA and/or the adherends to creep. Creep is the plastic deformation of a material that is subjected to a stress below its yield stress when that material is at a high homologous temperature. The homologous temperatures involved in creep processes are greater than ⅓. Homologous temperature refers to the ratio of a materials temperature to its melting temperature.

### Examples

The disclosure having been generally described, the following examples are given as particular embodiments of the disclosure and to demonstrate the practice and advantages thereof. It is understood that the examples are given by way of illustration and are not intended to limit the specification or the claims to follow in any manner. Hereinafter, unless otherwise indicated, the amount of components in a composition or formulation is presented as percentages which denote the weight percent of the component based on the total weight of the composition.

### Example 1

The ability to increase the melt flow rate of a polyolefin by reactive extrusion in the presence of an acrylate and an initiator was investigated. Specifically, EOD 02-15 was contacted with PRO 7011 and TRIGANOX 301 peroxide. EOD 02-15 is a 12 melt flow rate (MFR) metallocene catalyzed ethylene-propylene random copolymer available from Total Petrochemicals; PRO 7011 is a 40/30/30 mixture of alkoxylated lauryl acrylate, 2(2-ethoxyethoxy)ethylacrylate, and ethoxylated trimethylpropane triacrylate commercially available from Sartomer; and TRIGANOX 301 is 3,6,9-triethyl-3,6,9-trimethyl-1,4,7-triperoxonane commercially available from Azko Nobel. The samples were prepared by contacting the components to form a mixture which was then fed to a Leistritz MICRO-27 twin screw extruder. Four samples, Samples 1-4, were prepared and the sample formulation and processing conditions are given in Table 9.

TABLE 9

| | | | | Processing | | |
|---|---|---|---|---|---|---|
| | Formulation, wt. % | | | Conditions | | |
| | | Acrylate/ | Peroxide | | Extruder | MFR |
| Sample | | Peroxide | % of | Rate | Speed | (g/10 |
| No. | RESIN | premix | Monomer | (lb/hr) | (rpm) | min.) |
| 1 | 85 | 15 | 1.5 | 10 | 250 | 86 |
| 2 | 85 | 15 | 1.5 | 30 | 250 | 99 |
| 3 | 70 | 30 | 1.5 | 10 | 250 | 120 |
| 4 | 70 | 30 | 1.5 | 20 | 250 | 119 |

The melt flow rates of each sample are shown to increase from that of the base resin, 12 g/10 min., to over 100 g/10 min. for samples 3 and 4. Further, variations in the ratio of components resulted in variations in the MFR which may allow for tailoring of the formulations to a user-desired MFR.

### Example 2

The production of polyolefin-acrylate block copolymers by reactive extrusion was investigated. Specifically, five samples, designated samples 5-9, were prepared by combining EOD 02-15 with CD560 and TRIGANOX 301 peroxide in the amounts indicated in Table 10. CD 560 is an alkoxylated hexanediol diacrylate monomer commercially available from Sartomer. The weight percents given in Table 10 are the percent weight of the component based on the total weight of the mixture. Compounds were produced on a Leistritz Micro-27 twin-screw, 48:1 L/D with 12 temperature block zones using the following processing conditions:
Zone Temperatures: 320-320-325-330-335-340-340-340-340-340-340-340° F.
Feedstock: polypropylene at main feed: TRIGANOX 301 at zone 3; and CD 560 at zone 6
Total throughput rate” 20 lbs/hr
Screw speed: 250 rpm

Each sample was subjected to vacuum devolitization. The melt flow rates for each sample were determined and are also presented in Table 10.

TABLE 10

| | Weight percent of component (wt. %) | | | |
|---|---|---|---|---|
| | | TRIGANOX | CD560 | MFR |
| Sample No. | RESIN | peroxide | acrylate | (g/10 min.) |
| 5 | 95 | 0.09 | 5 | 114 |
| 6 | 95 | 0.11 | 5 | 134 |
| 7 | 85 | 0.09 | 15 | 236 |
| 8 | 85 | 0.11 | 15 | 351 |
| 9 | 85 | 0.18 | 15 | 334 |

The results demonstrate the reactive extrusion of the EOD 02-15 resin, which is a metallocene ethylene propylene random copolymer, with a peroxide initiator and an acrylate resulted in a polymeric material having MFRs ranging from 114 g/10 min. to 351 g/10 min. which is increased relative to the base resin with a MFR of 12 g/10 min.

A qualitative experiment was carried out in order to assess the adhesion of a MR and a POPA both of the type described herein. Two samples designated A and B were prepared from EOD 02-15 or a EOD 02-15/CD 560/TRIGANOX mixture respectively. The EOD 02-15/CD 560/TRIGANOX mixture contained 85 wt. % EOD 02-15 and 15 wt. % CD 560 based on the total weight of the composition. The mixture also contained 1.5 wt. % TRIGANOX 301 based on the weight percent of acrylate. Samples A and B were subjected to reaction extrusion as described in Example 1 and the melt deposited onto aluminum substrates. The melt was allowed to cool down slowly to ambient temperature. When the aluminum substrate having Sample A was bent manually, the layer readily peeled off. Similar tests carried out on Sample B deposited on an aluminum substrate showed no signs of peeling off. Sample B was eventually removed from the aluminum substrate by hand peeling with difficulty. The results demonstrate that a reactive extrusion formulation displayed adhesion between dissimilar substrates that was greater than that observed with an otherwise similar composition lacking the acrylate containing compound. The results suggest the polyolefin/polyacrylate formulations are suitable for hot melt adhesive applications.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A method comprising:
reactively extruding a polyolefin, an acrylate containing compound, and an initiator to form a polyolefin/polyacrylate blend; and
applying the blend in a melted form to one or more substrates.

2. The method of claim 1 wherein the polyolefin has a melt flow rate of from 0.5 g/10 min. to 2000 g/10 min.

3. The method of claim 1 wherein the polyolefin comprises polypropylene, polyethylene, a polypropylene homopolymer, a high crystallinity polypropylene, a high density polyethylene, a low density polyethylene, a linear low density polyethylene, or combinations thereof.

4. The method of claim 1 wherein the polyolefin is present in an amount of from 50 wt. % to 99.8 wt. % based on the total weight of the blend.

5. The method of claim 1 wherein the acrylate containing compound comprises an acrylic ester, an alkoxylated nonylphenol acrylate, a metallic diacrylate, a modified metallic diacrylate, a trifunctional acrylate ester, a trifunctional methacrylate ester, ethoxylated trimethylolpropane triacrylate, propoxylated glycerol triacrylate, tripropylene glycol diacrylate, 2-(2-ethoxyethoxy)ethyl acrylate, ethoxylated (15) trimethylolpropane triacrylate, ethoxylated (30) bisphenol A diacrylate, ethoxylated (30) bisphenol A dimethacrylate, ethoxylated (20) trimethylolpropane triacrylate, methoxy polyethylene glycol (350) monoacrylate, methoxy polyethylene glycol (350) monomethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol monomethacrylate, 1,12-dodecanediol methacrylate, 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, acrylate ester, alkoxylated aliphatic diacrylate, alkoxylated cyclohexane dimethanol diacrylate, alkoxylated hexanediol diacrylate, alkoxylated neopentyl glycol diacrylate, cyclohexane dimethanol diacrylate, diethylene glycol diacrylate, diethylene glycol dimethacrylate, dipropylene glycol diacrylate, ethoxylated (10) bisphenol A diacrylate, ethoxylated (2) bisphenol A dimethacrylate, ethoxylated (3) bisphenol A diacrylate, ethoxylated (4) bisphenol A diacrylate, ethoxylated (4) bisphenol A dimethacrylate, ethoxylated (8) bisphenol A dimethacrylate, ethoxylated bisphenol A dimethacrylate, ethoxylated (10) bisphenol dimethacrylate, ethoxylated (6) bisphenol A dimethacrylate, ethylene glycol dimethacrylate, neopentyl glycol diacrylate, nenopentyl glycol dimethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol (1000) dimethacrylate, polyethylene glycol dimethacrylate, polypropylene glycol (400) dimethacrylate, propoxylated (2) neopentyl glycol diacrylate, tetraethylene glycol diacrylate, tetraethylene glycol dimethacrylate, tricyclodecane dimethanol diacrylate, triethylene glycol diacrylate, or combinations thereof.

6. The method of claim 1 wherein the acrylate containing compound is present in an amount of from 0.2 wt. % to 50 wt. % based on the total weight of the blend.

7. The method of claim 1 wherein the initiator comprises an organic peroxide.

8. The method of claim 7 wherein the organic peroxide comprises benzoyl peroxide, lauroyl peroxide, t-butyl peroxybenzoate, 1,1-di-t-butylperoxy-2,4-di-t-butylcyclohexane, diacyl peroxides, peroxydicarbonates, monoperoxycarbonates, peroxyketals, peroxyesters, dialkyl peroxides, hydroperoxides, or combinations thereof.

9. The method of claim 1 wherein the initiator is present in an amount of from 0.2 wt. % to 3 wt. % based on the weight of the acrylate containing compound.

10. The method of claim 1 the blend further comprises a tackifier.

11. The method of claim 1 wherein the tackifier comprises an alkylphenolic, a coumarone-indene, an aliphatic hydrocarbon, a cycloaliphatic hydrocarbon, an aromatic hydrocarbon resin, a rosin, an aromatically modified aliphatic hydrocarbon and hydrogenated derivatives thereof; an aromatically modified cycloaliphatic hydrocarbon and hydrogenated derivatives thereof; polyterpene, styrenated polyterpene, or combinations thereof.

12. The method of claim 1 wherein the blend further comprises a processing oil.

13. The method of claim 12 wherein the processing oil comprises a mineral oil.

14. The method of claim 1 wherein the one or more substrates comprise paper, corrugated board, chip board, cardstock films, metal, plastics, glass, wood, leather and textile materials, filmic materials, polyolefins, polystyrenes, polyamides, polyesters, plasticized polyesters, copolymers of acrylonitrile, of styrene, of butadiene, polyvinyl chloride (PVC), polycarbonate, rubber, or combinations thereof.

15. The method of claim 1 wherein two or more substrates are adhered to form a multilayer article.

16. The method of claim 15 wherein the substrates that are adhered comprise polyolefin-to-polyolefin substrates, polyolefin-to-polyvinyl chloride substrates, polyolefin-to-wood substrates, polyolefin-to-metal substrates, polyolefin-to-nylon substrates, polyolefin-to-polystyrene substrates, and polyolefin-to-rubber substrates.

17. The method of claim 1 wherein the blend crosslinks to the substrate.

18. The method of claim 1 wherein the blend has a melt flow rate of from 10 g/10 min. to 50,000 g/10 min.

19. A method comprising:
extruding a metallocene ethylene-propylene random copolymer to form a melt, wherein the copolymer has a melt flow rate of from 0.5 g/10 min. to 2000 g/10 min.; and
applying the melt to one or more substrates.

20. A method comprising:
reactively extruding a metallocene ethylene-propylene random copolymer, an acrylate containing compound, and a peroxide to form a polyolefin/polyacrylate blend, wherein the blend has a melt flow rate of greater than 100 g/10 min.; and
applying the blend in a melted form to one or more substrates.

21. A hot melt adhesive prepared according to the method of claim 1.
